(19) United States
(12) Patent Application Publication
(10) Pub. No.: US 2014/0000288 A1
(43) Pub. Date: Jan. 2, 2014

(54) APPARATUS FOR STORING HYDROGEN AND MAGNETIC ENERGY AND A METHOD FOR THE OPERATION OF SAID APPARATUS

(71) Applicants: Holger Neumann, Weingarten (DE); Michael Sander, Eggenstein-Leopoldshafen (DE)

(72) Inventors: Holger Neumann, Weingarten (DE); Michael Sander, Eggenstein-Leopoldshafen (DE)

(73) Assignee: Karlsruhe Institut Fuer Technologie, Karlsruhe (DE)

(21) Appl. No.: 14/004,370

(22) PCT Filed: Mar. 6, 2012
(86) PCT No.: PCT/EP12/00985

§ 371 Date: Sep. 10, 2013

(30) Foreign Application Priority Data
Mar. 10, 2011 (DE) 10 2011 013 577.4

(51) Int. Cl. F17C 5/04

(52) U.S. Cl. CPC F17C 5/04
USPC 62/3.1

(57) ABSTRACT

An apparatus for storing hydrogen and magnetic energy includes a storage tank for liquefied hydrogen with an inlet line for compressed hydrogen and an outlet line for hydrogen at a relatively low pressure. The apparatus includes a superconducting magnetic energy store, which comprises a magnetic coil relative to which electrical energy can be supplied or withdrawn via power supply lines to the magnet coil, the energy being located in a cryogenic tank provided with a cooling device and being held at operating temperature. The storage tank for liquefied hydrogen includes cooling device, at least one regenerator, with a heat-absorbing and heat-emitting storage medium, a warm side and a cold side. From the warm side, the compressed hydrogen and, from the cold side, liquefied hydrogen can be supplied from the storage tank for liquefied hydrogen. A relief valve is located in the field region of the at least one magnet coil. The relief valve is connected to the cold side of the regenerator so the compressed hydrogen, having passed through the regenerator, can be fed into the relief valve and, owing to the pressure relief, can be supplied, at least partially as liquefied hydrogen to the storage tank for liquefied hydrogen.

The invention relates to an apparatus for storing hydrogen, comprising an inlet line for compressed hydrogen as well as an outlet line for hydrogen at a lower pressure, and for storing magnetic energy.

The increasing share of fluctuating regenerative energy sources used to supply electrical power requires additional measures for balancing feed-in fluctuations. Liquefied hydrogen which has a high volumetric energy density is suitable for this as energy store and as fuel. Compared to the compressing of hydrogen, however, a higher amount of electrical energy is required for liquefying hydrogen which typically amounts to approximately 30% of the upper heating value of hydrogen as compared to approximately 10% for the compressing to approximately 15 MPa to 20 MPa.

According to H. Quack in “DIE SCHLÜSSELROLLE DER KRYOTECHNIK IN DER WASSERSTOFF-ENERGIEWIRTSCHAFT” [the Key Role of Cryogenics in the Hydrogen Energy Management], T U Dresden, http://images, energie-portal 124.de/dateien/downloads/verfluessigung-dresden.pdf, industrial-size hydrogen liquefying apparatuses normally operate with several continuous gas flows, with heat exchangers (recuperators) through which gas flows simultaneously in counter-flow directions, with several gas return lines, with expansion machines for the refrigeration at intermediary temperatures, and with separate loops for the ortho-para conversion required with the hydrogen. The hydrogen which is at last liquefied in a relief valve can then be removed and transported to the location of application. A large share of the electrical energy needed for the liquefying is not used during the warming up at the location of application.

Processes where gas flows alternately from the cold and the warm side through a regenerator or regenerative heat exchanger are known from small cooling devices; see also R. Radebaugh, Cryocoolers: the state of the art and recent developments, J. Phys.: Condens. Matter 21 (2009) 164219. For the Stirling process, a stationary reactor and, in the cold section, a mechanically operated expansion piston is used. With the Gifford-McMahon process, a mechanically operated regenerator is used as displacement piston. Pulse tube coolers also require the gas to pass through cycle processes, wherein the mechanical piston or displacer in that case is replaced by a pulsing gas column. These methods have in common that they are restricted to maximum structural dimensions that extend to the kW range, that they operate at frequencies of 50 Hz to 1 Hz, and that they are primarily used for the refrigeration, but not for the liquefying of gas.

In the case of hydrogen, it is necessary to take into consideration the two spin states of the hydrogen molecule which differ energetically by a conversion heat at the level of approximately 1.5 times the liquefying enthalphy. In practical operations, the hydrogen must therefore be as close as possible to the ortho-para balance during each processing step that is connected to cooling, storing and reheating. To meet this requirement, catalysts are normally used for the ortho-para conversion during the cooling process, as disclosed in R. Gross, W. Otto, A Patzelt, M. Wanner, “FLÜSSIGWASSERSTOFF FÜR EUROPA—DIE LINDE ANLAGE IN INGOLSTADT” [Liquid Hydrogen for Europe—the Linde Plant at Ingolstadt], Linde reports from the magazine TECHNIK UND WISSENSCHAFT [Technology and Science] 71/1994, pages 36-42. However, this requires gas return lines and the availability of additional cooling or refrigeration capacity are needed at intermediate temperatures.

The DE 10 2007 042 711 A1 discloses the use of liquefied hydrogen as energy store for longer storage periods in combination with a superconducting magnetic energy store (SMES), used therein for the short-term storage.

The DE 38 43 065 A1 discloses the use of a magnetic coil for a magneto-caloric liquefying stage. The magnetic field in this case functions to successively magnetize and demagnetize paramagnetic and ferromagnetic materials in a cyclical process during which the magneto-caloric effect generates cold which can be used to liquefy gases such as hydrogen.

The DE 196 00 936 A1 discloses a membrane fuel cell, surrounded by a HTSL coil/hollow-cylinder storage device, as well as a semiconductor HTSL photo-voltaic cylinder. Gaseous hydrogen and oxygen, separated by catalyst and a membrane, flow from both sides into a porous distributor. During the hydrogen/oxygen reaction, an electric current is generated in the current collector for which the voltage can be tapped at the poles, as well as water which escapes at the outlet. The HTSL coil that surround the membrane fuel cell and the HTSL hollow cylinder are cooled with liquid hydrogen and function as additional second/minute storage devices. The p/n doped semiconductor HTSL photo-voltaic cylinder generates additional solar current. The hydrogen which evaporates as a result of sun irradiation is liquefied once more with the aid of the heat exchanger and the magneto-caloric HTSL regeneration stages and is returned to the HTSL cooling system in the liquid state or is returned in the gaseous state to the fuel cell. During the reversal of the process of the fuel cell reaction, meaning the electrolysis, the same membrane arrangement functions to generate hydrogen from water, which is then liquefied magneto-caloric as cooling agent HTSL. A share of the electrical energy for the electrolysis can be generated by the p/n semiconductor HTSL photo-voltaic cylinder.

The DE 101 06 483 A1 discloses circumventing at least one catalyst for the ortho-para conversion during the liquefying process in order to avoid the refrigeration capacity. This method is advantageous in cases where only short storage times are required for the liquefied hydrogen, in particular when it is used in a hydrogen-operated vehicle shortly after being generated.

Starting with this premise, it is the object of the present invention to provide an apparatus that is reliable and is configured with the fewest possible components for the intermediate storage of hydrogen and magnetic energy, as well as a method for operating said apparatus, which overcome the disadvantages and restrictions of the prior art.

In particular, an apparatus is to be made available which balances the known efficiency advantage of compressed hydrogen and, together with the additional function of the electrical energy storage in the superconducting magnetic energy store (SMES), provides an energetically advantageous type of storage for hydrogen in the liquefied form.

This object is solved regarding the apparatus with the features disclosed in claim 1 and regarding the method for operating said apparatus with the method steps disclosed in claim 5. The dependent claims respectively describe advantageous embodiments of the invention.

An apparatus according to the invention comprises in particular:
A superconducting magnetic store (SMES), configured with at least one magnetic coil, to which can therefore be supplied at the operating temperature electrical energy in the faun of a magnetic field, and from which said energy can be extracted again, and which is cooled with a liquid cooling agent, as well as the following components which are all located in the range of the magnetic field of the at least one magnetic coil;
A storage tank for liquefied (liquid) hydrogen (LH2);
At least one regenerator (thermal mass storage device), wherein the hydrogen is cooled during the feed-in and is heated during the removal; and
A relief valve, in particular a Joule-Thomson relief valve, for liquefying the compressed hydrogen which is pre-cooled in the at least one regenerator and for subsequently feeding it into the storage tank for liquid hydrogen (LH2),
   wherein—owing to the magnetic field of the at least one magnetic coil—the ortho-para conversion and/or the para-ortho reconversion of the hydrogen is supported in the at least one regenerator.

On the one hand, the apparatus according to the invention is based on the use of regenerators, meaning thermal mass storage devices, instead of recuperators which are counter-current heat exchangers while, on the other hand, the magnetic field of the at least one magnetic coil of the superconducting magnetic store (SMES) makes it possible to completely omit catalysts for the ortho-para conversion as well as for the para-ortho reconversion. Apart from simple shut-off valves, moving masses and gas return lines can thus be omitted in the cold region.

The at least one regenerator which, according to one favorable embodiment, is located at least partially in a chamber under vacuum conditions, is configured with one or several storage media that absorb heat or release heat. Since the regenerator is operated in a strong magnetic field that changes and since the heat inputs and the cooling losses resulting therefrom are to be kept low, mostly non-magnetic and electrically insulating storage media with simultaneously high heat capacity are especially suited for this.

The at least one regenerator is typically operated between the ambient temperature and a temperature which can reach no more than 35K. For that reason, a subsequent expansion of the hydrogen, which is compressed to a sufficiently high pressure, to a pressure of approximately 0.1 MPa already makes possible a far-reaching liquefying. A direct liquefying at approximately 0.1 MPa, on the other hand, would require that the complete liquefying enthalpy (evaporation heat) would have to be extracted precisely at the boiling point for hydrogen, which is not only hard to realize but would also be quite inefficient. It is therefore advantageous if the hydrogen is initially compressed to supercritical pressures at the ambient temperature and is then liquefied with the aid of a relief valve.

The liquefying and cooling enthalpy of the hydrogen is extracted during the heating phase, following the storage phase, from the at least one regenerator which can later remove these enthalpies over a broad temperature range from the compressed hydrogen during the renewed cooling.

According to a special embodiment, the at least one regenerator is spatially arranged such that it is positioned above the storage tank for the liquefied hydrogen, wherein respectively the cold end of the at least one regenerator faces the liquid surface of the liquefied hydrogen bath (LH2 bath) and, in this way, facilitates a release of the liquefied hydrogen into the storage tank.

To thermally stabilize the at least one regenerator at its cold end, one preferred embodiment provides for a thermal contact between the LH2 bath and the cold end of the at least one regenerator, by means of which a portion of the at least one regenerator can also be held in place mechanically.

To reduce in particular the heat input into the storage tank for liquefied hydrogen (LH2), the tank according to one especially preferred embodiment is mostly surrounded by a so-called radiation shield that is cooled with liquid nitrogen (LN2). At the same time, this bath of liquid nitrogen (LN2 bath) also serves to provide a better thermal stabilization of the at least one regenerator during changing operating conditions, wherein this thermal contact to the LN2 bath can furthermore also be used for mechanically holding in place at least parts of the at least one regenerator. According to an alternative embodiment, liquid oxygen LO2 is used in place of the liquid nitrogen LN2.

A method according to the invention comprises the steps a) to d).

According to step a), the operating current for a superconducting magnetic energy store (SMES) that is configured with at least one magnetic coil is adjusted via current supply lines. As a result, electrical energy is supplied to, is stored in, or is drawn from the connected magnetic coil. With this step already, energy can thus be supplied for a short time.

To supply energy over a longer period of time, the stored hydrogen is additionally used, which is preferably generated in an electrolyser and is once more converted to electrical current in a fuel cell.

It is essential for the operating mode according to the invention that the magnetic field intensity at all locations of the at least one regenerator, of the (Joule Thomson) relief valve, and of the storage tank for the liquefied hydrogen does not drop below a fixed lower limit. Only in this way is it ensured that the magnetic field supports the ortho-para conversion and/or the para-ortho reconversion of the hydrogen in such a way that for each temperature a far-reaching thermal balance adjusts between the two spin states.

According to step b), compressed hydrogen is supplied at the ambient temperature via the warm end of the at least one regenerator, is cooled in the at least one regenerator through releasing heat to the at least one storage medium therein, is then allowed to expand to a lower pressure in the (Joule Thomson) relief valve and, in the process, is mostly liquefied, and is finally in step c) caught and stored in the storage tank in the form of liquefied hydrogen as LH2 bath.

According to step d), the liquefied hydrogen (LH2) is removed as needed from the LH2 bath in the storage tank and is supplied to the cold end of the at least one regenerator, is warmed up therein through heat absorbed from the at least one storage medium, and is discharged via the warm end of the at least one regenerator in the form of gaseous hydrogen (GH2).

To ensure a reliable operation, the at least one regenerator is furthermore stabilized thermally through contact with cold baths.

For this, the cold end of the at least one regenerator is stabilized to the temperature level of the LH2 bath according to a first embodiment.

According to a different embodiment, at least a portion of the at least one regenerator is stabilized to the temperature level of a LN2 bath or a LO2 bath.

In the case where oxygen is to be used for the thermal stabilization of the at least one regenerator, the oxygen is generated together with the hydrogen in a high-pressure electrolyser, is then initially also cooled through heat transfer, the pressure is allowed to expand and, in the process, the oxygen cooled down further and/or is partially liquefied. The use of a high-pressure electrolyser reduces the electrical energy that is otherwise required for the compression.

The proposed combination of liquid hydrogen and superconducting magnetic storage device (SMES) makes available control power for the electrical mains along time scales ranging from seconds, to hours, and days, thereby contributing to buffering the increased share in the power supply of fluctuating wind power and sun power. In particular, this approach supports the incentive to use liquefied hydrogen instead of compressed hydrogen.

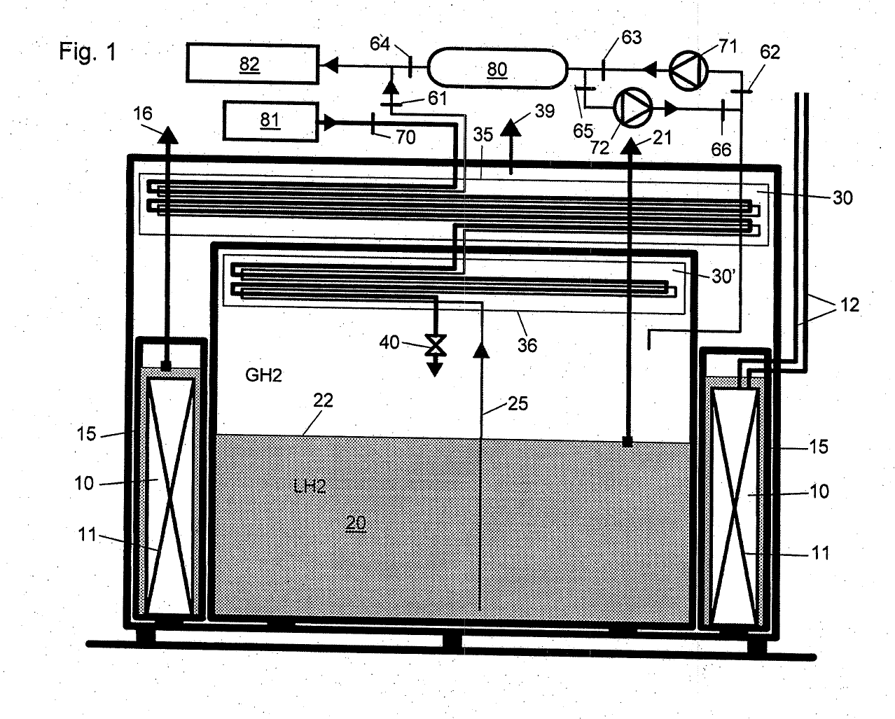

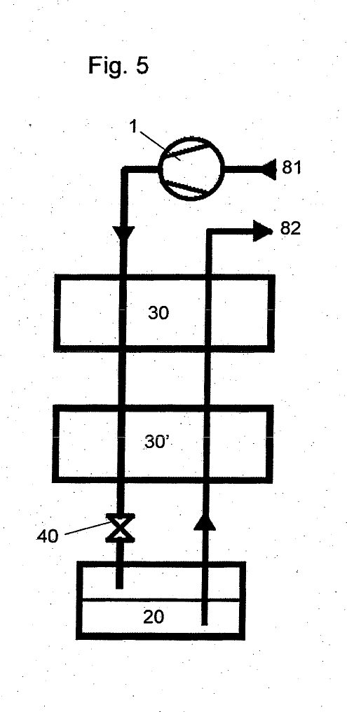

The invention is explained in further detail in the following with the aid of exemplary embodiments and the Figures. FIGS. 1 to 4 hereby contain exemplary embodiments for an apparatus according to the invention, whereas FIGS. 5 to 10 illustrate the inventive method for operating said apparatus. Concerning the abbreviations, we point to the Reference List.

The Figures show in detail:

FIG. 1 A schematic representation of an apparatus according to the invention, comprising a regenerator with separate flow channels, of which at least a portion is located inside the storage tank under GH2 conditions;

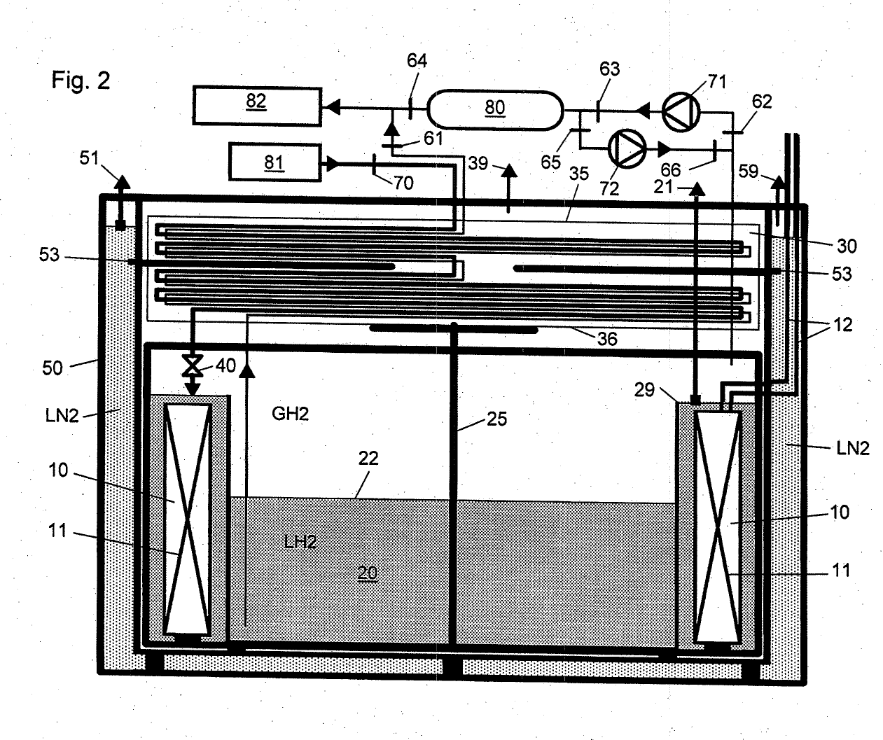

FIG. 2 A schematic representation of an apparatus, comprising a regenerator with LN2 and LH2 stabilization and separate flow channel, as well as a superconducting, magnetic energy storage device (SMES), operated in the LH2 bath;

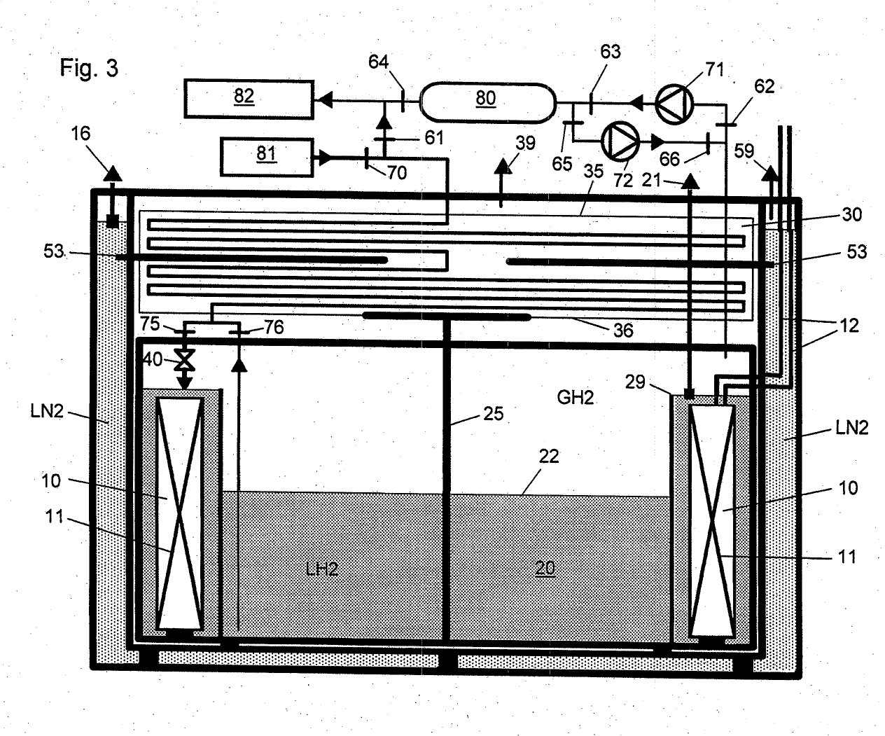

FIG. 3 A schematic representation of an apparatus, comprising a regenerator with LN2 and LH2 stabilization, joint flow channels and valves in the cold region, as well as a SMES that is operated in the LH2 bath;

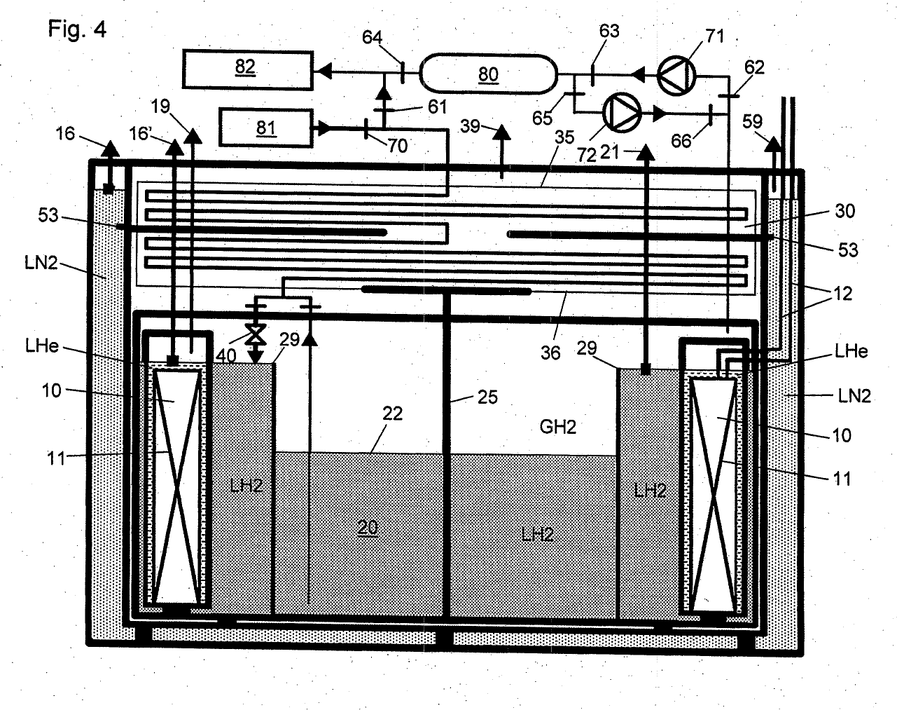

FIG. 4 A schematic representation of an apparatus, comprising a regenerator with LN2 stabilization and LH2 stabilization and separate flow channels, as well as a SMES that operates in the LHe bath;

FIG. 5 A flow chart showing the sequence of steps for a first method according to the invention for storing hydrogen;

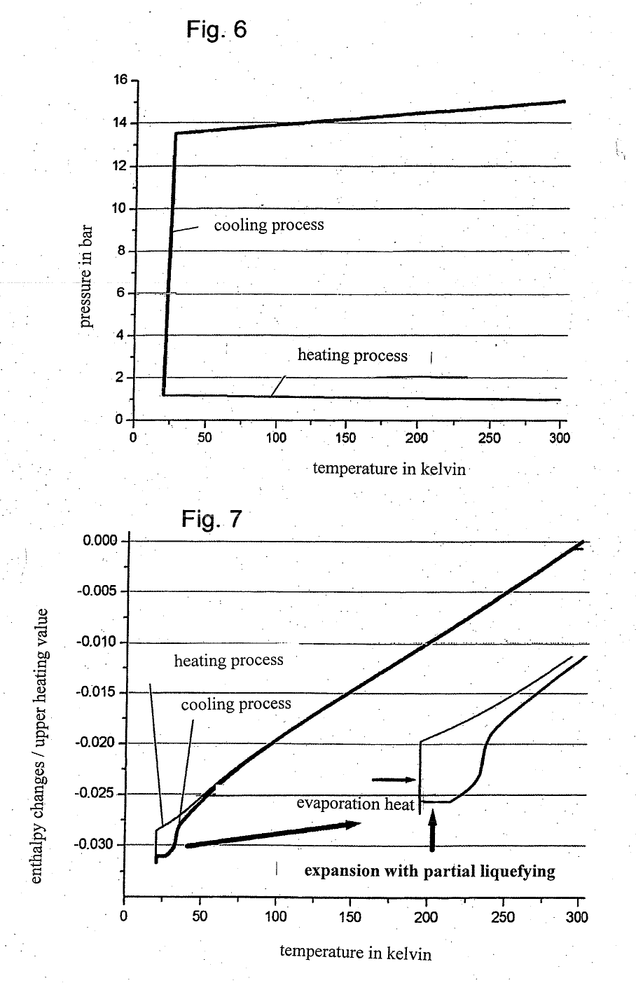

FIG. 6 An example for the pressure course during the cooling and the heating process according to the invention;

FIG. 7 An example for the course of the enthalpy during the cooling and heating process according to the invention;

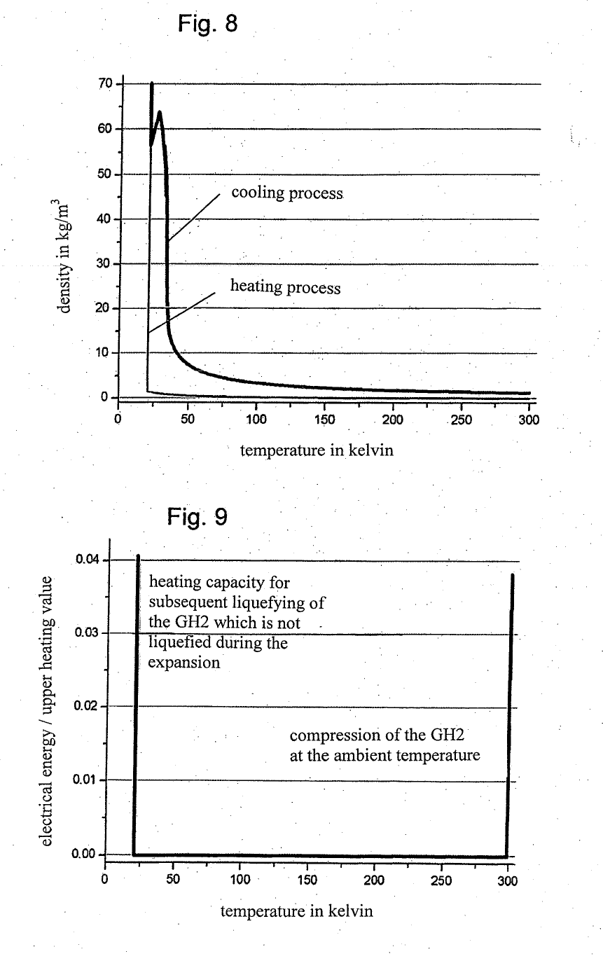

FIG. 8 An example of the density course during the cooling and heating process according to the invention;

FIG. 9 An example for the electrical energy that must be expended according to the invention for compressing the GH2 at the ambient temperature, as well as for the cooling at the temperature of the boiling LH2 at the end of the cooling process;

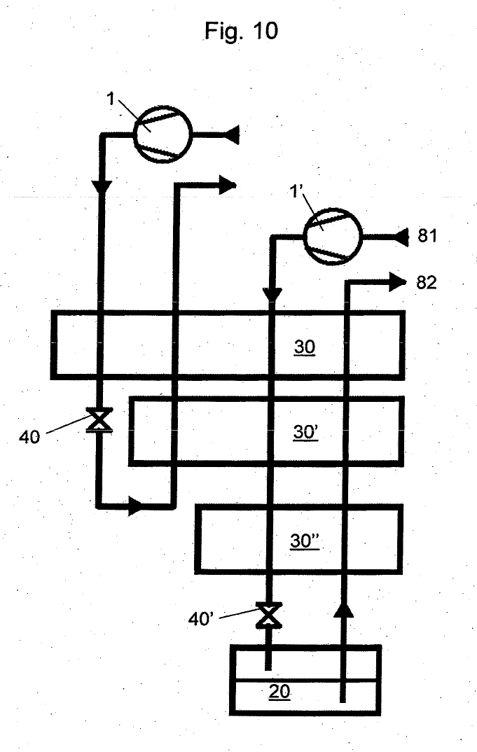

FIG. 10 A flow chart showing the sequence of steps for another method according to the invention for storing hydrogen.

FIG. 1 shows schematically—meaning not true to scale—an exemplary embodiment for an apparatus according to the invention. A cryogenic container with vacuum pump 39 contains a cryogenic tank 15 for the superconducting magnetic energy store 10, as well as a separate storage tank 20 for liquid hydrogen LH2. The regenerator 30 is embodied with separate flow channels for liquids arriving from the warm end 35 and from the cold end 36, wherein at least a portion of it is located in the storage tank 20 under GH2 conditions. Arranged at the cold end 36 are the Joule Thomson relief valve 40 and the LH2 supply via a riser. Arranged at the warm end 35 are the compressed hydrogen inlet with the high-pressure shut-off valve 70 and the outlet for discharging the hydrogen at a lower pressure, along with the shut-off valve 61 which is also operated at the ambient temperature. The low-pressure region is furthermore connected via the shut-off valve 64 to control elements for the pressure control in the LH2 storage tank 20. A tank 80 for gaseous hydrogen, which serves as buffer for pressure fluctuations, takes in GH2 from the cold region on the intake side via the shut-off valve 62, the condenser 71 and another shut-off valve 63 and releases GH2 into the cold region via the shut-off valve 65, the condenser 72 and the additional shut-off valve 66. The two lines for the GH2 make it possible to reduce and increase the pressure in the LH2 store and thus control and regulate the discharge of liquid hydrogen from the LH2 store. The superconducting magnetic energy store 10 and the LH2 storage tank 20 are thermally stabilized with the aid of the cooling devices 16, 21 (e.g. a small cooler). The power supply lines 12 establish the electrical connection to the current rectifier and to the control unit for the energy store 10.

An alternative embodiment uses an expansion machine, a turbine in this case, in place of a Joule-Thomson relief valve 40. A cold LH2 pump is additionally installed at the outlet for discharging the LH2 from the storage tank. However, as a result of the masses rotating in the strong magnetic field, this arrangement has the disadvantage of inducing eddy currents in the cold region which lead to additional heat input and thus a cooling loss.

FIG. 2 schematically illustrates an advantageous exemplary embodiment for an apparatus according to the invention, for which the regenerator 30 is located completely in a separate chamber under vacuum conditions, thereby reducing the heat input into the regenerator 30 through free convection of gas particles. The regenerator 30 in this case is arranged spatially above the storage tank 20 for LH2 and the cold end 36 of the regenerator 30 is connected directly to the LH2 bath via a thermal contact 25 which in this case also serves as mechanical holder for the regenerator 30. Furthermore provided as radiation shield is an outside tank 50 for liquid nitrogen LN2 which can be filled with LN2 via the inlet 59 and is additionally thermally stabilized with the aid of another cooling device 51 (e.g. a small cooler). At the same time, a portion of the regenerator 30 is stabilized via the thermal contact 53 to the LN2 bath, to match the temperature of the LN2, wherein the holder anchored in the container wall simultaneously also functions to spatially fixate the regenerator 30.

The superconducting, magnetic energy store 10 is operated at the temperature of the liquefied hydrogen LH2. The cryogenic tank 15 of the energy store 10 represents a section of the LH2 storage tank 20 that is open toward the top, is supplied via the Joule Thomson relief valve 40 with liquefied hydrogen LH2, and is connected by means of a LH2 overflow line 29 to the main section of the storage tank 20. This configuration ensures that the energy store 10 is still cooled completely, even with a partial emptying of the LH2 tank 20 and the resulting lowering of the liquid level 22.

The exemplary embodiment shown in FIG. 3 differs from the exemplary embodiment according to FIG. 2 in that the liquid coming from the warm end 35 and the liquid coming from the cold end 36 flow at the same time, but with a time offset in opposite flow direction through one or several flow channels, e.g. filled with bulk good, of the regenerator 30. Two shut-off valves are provided for this at the cold end of the regenerator 30, meaning the valve 75 by way of which the compressed hydrogen is supplied to the Joule Thomson relief valve 40 and the valve 76 which is also operated in the cold region and functions to supply the liquid hydrogen LH2 to the regenerator 30. The two valves 70 and 61, which control the intake of the compressed hydrogen at the warm end 35 of the regenerator 30 and the discharge of the hydrogen at a lower pressure, are both connected to a joint flow channel.

FIG. 4 schematically illustrates another exemplary embodiment of an apparatus according to the invention for which the superconducting magnetic energy store 10 is operated at the temperature of the liquid helium LHe, in contrast to the exemplary embodiment according to FIG. 3. To be sure, the separate cryogenic tank 15 of the energy store 10 is enclosed for this by a chamber of the LH2 storage tank 20 that functions as a heat shield, but remains separated from it. The cryogenic tank for the energy store 10 can be filled via the intake 19 and can additionally be thermally stabilized with the aid of a cooling device 16′ for liquid helium (e.g. a small cooler).

The principle of the method according to the invention is illustrated in FIG. 5 with the aid of a flow chart. Gaseous hydrogen GH2 is compressed in a compressor 1 to a pressure that is typically above the critical pressure, subsequently passes through the regenerator 30, is then expanded and liquefied in the Joule Thomson valve 40 and is stored in a LH2 storage tank 20 until it is needed, at which point it is warmed up again via the regenerator 30 and is discharged once more at a lower pressure in the form of gaseous hydrogen GH2. The magnetic field of the superconducting magnetic energy store 10, which is not shown in FIG. 5, ensures even without catalyst that the two spin states of the hydrogen remain for the most part thermally balanced during each process step.

The operating mode according to the invention is introduced in FIGS. 6 to 9. FIG. 6 schematically shows an example of a pressure course for the hydrogen during the cooling process in the regenerator 30, the expansion in the Joule Thomson relief valve 40, and the subsequent warming process in the regenerator 30. It was assumed for this case that hydrogen is supplied at the ambient temperature and at a pressure of approximately 1.5 MPa, is discharged again at a pressure of approximately 0.1 MPa, and that the temperature of the liquefied hydrogen during the storage phase is maintained at approximately 20 to 23K. The pressure losses resulting from the flow through the regenerator 30 are indicated herein.

FIG. 7 illustrates the course of the hydrogen enthalpy during the process according to FIG. 6, starting with the ambient temperature. All values are standardized to the upper heating value for the hydrogen. The magnetic field of the superconducting magnetic energy store 10 in this case ensures that for each temperature setting it passes through a far-reaching balance adjusts between ortho hydrogen and para hydrogen. The changes in the enthalpy, which occur at the lowest temperatures, are shown enlarged in FIG. 7 for a better illustration. Upon passing through the regenerator during the cooling process, the Joule Thomson expansion follows for which the enthalpy remains for the most part constant (corresponds to the horizontal region of the cooling curve). In the process, most of the hydrogen is already liquefied. A smaller portion, however, remains in the gaseous state and must subsequently be liquefied with the aid of additional cooling capacity (see also FIG. 9). During the evaporation of the liquid hydrogen, the liquefying enthalpy, recognizable as a vertical line, is extracted from the regenerator as evaporation heat and the regenerator is thus cooled by the cold region. The evaporated hydrogen is then heated up more and in so doing also extracts more heat from the elements arranged on the warm side of the regenerator. The regenerator cooled down in this way is suitable for the pre-cooling for a later cooling operation. Owing to the incomplete heat transfer between the regenerator 30 and the hydrogen, the hydrogen exits the regenerator 30 at a temperature that is below the starting temperature for the cooling process, wherein this effect is indicated in FIG. 7 at 300 kelvin.

FIG. 8 illustrates the course of the hydrogen density during the same process. Below approximately 50K, the density of the compressed hydrogen increases strongly during the cooling process. During the expansion, the hydrogen density decreases slightly because of the incomplete liquefying and finally reaches the density of the liquid hydrogen as a result of additionally provided cooling capacity. The evaporation during the heating process is again tied to a strong reduction in the hydrogen density.

FIG. 9 indicates the two main shares of the electrical energy which are required to realize the method illustrated in FIGS. 6 to 8 for storing hydrogen. The first main share is the electrical energy needed for compressing the GH2 at the ambient temperature. The second main share is the electrical energy needed at the temperature of the boiling LH2, at the end of the cooling process, for the post-liquefying of the hydrogen that is not liquefied during the expansion. Additional shares of electrical energy, which are necessary for the thermal stabilization of the cryogenic unit or its control, were not shown herein. If we add the two main shares, we obtain an electrical energy consumption of approximately 8% of the upper heating value of hydrogen which, on the one hand, is clearly lower than the share of approximately 30% required for the liquefying in larger systems and, on the other hand, is comparable to the level of approximately 10%, which is typically needed for the compression to 15 to 20 MPa.

FIG. 10 contains a further exemplary embodiment for the hydrogen storage process, in the form of a flow chart. As compared to FIG. 5, the process was expanded through pre-cooling with oxygen. Gaseous oxygen is compressed in an additional compressor or, alternatively, can also be generated at high pressure together with the hydrogen in a high-pressure electrolyser, then passes through the regenerator as well, is subsequently expanded in a further Joule Thomson valve and, in the process, is cooled or liquefied, thereby contributing to the thermal stabilization of the regenerator through which the hydrogen flows.

Particularly advantageous embodiments are obtained when selecting the following parameters:

The superconducting magnetic energy store 10 is operated locally with magnetic fields in the range of 1-30 T, preferably of 4-11 T, while the operating current is changed in the range of 30% to 100%, wherein the magnetic field intensity at all locations of the at least one regenerator, the (Joule Thomson) relief valve, and the storage tank for the liquefied hydrogen preferably does not fall below a minimum limit of 0.1 T, especially preferred not below 1 T.

Superconducting materials which can be used for generating magnetic fields at the temperature of the liquefied hydrogen include, in particular, BiSrCaCuO, YBaCuO or MgB2. A direct synergy between the storage of LH2 and the operation of the superconducting magnetic energy store 10 thus results if, as shown in FIGS. 2 and 3, the energy store 10 is operated at the temperature of the liquefied hydrogen and if the cryogenic tank for the SMES is part of the storage tank 20 for LH2.

According to FIG. 4, the energy store 10 of an alternative embodiment is operated with traditional superconductors, preferably on the basis of NbTi, at the temperature of the liquid helium LHe. For this, a separate LHe cryogenic tank is used for the energy store 10 which is at least partially enclosed for a better heat screening by a chamber of the storage tank for the LH2, which is connected via a LH2 overflow line to the other part of the storage tank 20.

The storage media of the at least one regenerator 30 advantageously have a magnetic susceptibility with an absolute value below 10⁻⁵, an electrical conductivity of less than 10⁻⁸ S/m and a volume-referenced specific thermal capacity above 20 MJ/M³·K. These properties can be found in particular in Teflon or other materials on the basis of solid hydrocarbons.

The compressed hydrogen, which is supplied via the warm end of the at least one regenerator 30, is preferably compressed to a pressure above 1.3 MPa and, following the passage through the at least one regenerator 30, is then expanded in the (Joule Thomson) relief valve 40 to an expansion pressure below 0.1 MPa. Since the pressure levels depend on the hydrogen pressure desired for the discharge, the pressure in the storage tank 20 is adjusted via the pressure control, such that it exceeds the expansion pressure during the storage phase by at most 0.2 MPa. The temperature of the liquefied hydrogen is also adjusted via the pressure control and the cooling device 21 attached to the storage tank 20, such that it is maintained in the range of 18-35K. When exiting the at least one regenerator 30 following the storage phase, the hydrogen has a temperature of no more than 30K below the ambient temperature.

### LIST OF REFERENCES

GH2 gaseous hydrogen
LH2 liquefied hydrogen
LN2 liquefied nitrogen
LHe liquefied helium
1 compressor for compressing to the feed-in pressure
10 superconducting magnetic energy store
11 magnetic coil of the energy store 10
12 feed lines to the current rectifier and control unit for the energy store 10
15 cryogenic tank for the energy store 10
16 cooling device for the SMES
19 feed-in and pressure control for the LHe
20 storage tank for LN2
21 cooling device for the LH2 bath
22 liquid level in the storage tank 20
23 thermal contact to the LN2 bath
25 thermal contact to the LH2 bath
29 overflow line for LH2
30 regenerator
35, 36 warm end and/o r cold end of the regenerator
39 connecting line to the vacuum pump
40 Joule Thomson relief valve
50 outside tank for LN2
51 cooling device for the outside tank 50
59 feed-in and pressure control for LN2
61, 62, . . . shut-off valves in the warm region for switching operations at low pressure
70 shut-off valve for the high-pressure range at the ambient temperature
71, 72 GH2 compressor at low pressure in the warm region, for the pressure control in the LH2 cryogenic storage device
75 shut-off valve for the high pressure range in the cold region
76 shut-off valve for the LH2 feed line in the cold region
80 storage tank for GH2 at the ambient temperature
81 compressed hydrogen
82 hydrogen at low pressure

1. An apparatus for the storage of hydrogen, with an inlet line for compressed hydrogen as well as an outlet line for discharging hydrogen at a lower pressure, and for the storage of magnetic energy, said apparatus comprising a superconducting magnetic energy store that is configured with at least one magnetic coil, to which electrical energy can be supplied or from which electrical energy can be extracted via power supply lines to the at least one magnetic coil, which energy store is located in a cryogenic tank provided with a cooling device and is maintained at the operating temperature, characterized in that the field region of the at least one magnetic coil comprises a storage tank for liquefied hydrogen which is provided with an additional cooling device, at least one regenerator that is provided with at least one heat-absorbing and heat-releasing storage medium and has a warm side and a cold side, to which can be supplied from the warm side the compressed hydrogen and from the cold side the liquefied hydrogen from the storage tank for liquefied hydrogen, further comprising a relief valve which is connected to the cold side of the regenerator in such a way that the compressed hydrogen can be fed into the relief valve after passing through the regenerator and, following the expansion therein, can be supplied to the storage tank for liquefied hydrogen in the form of at least partially liquefied hydrogen.

2. The apparatus according to claim 1, characterized in that the at least one regenerator is located spatially above the storage tank for liquefied hydrogen, wherein the cold end of the at least one regenerator is facing the liquid surface of the liquid hydrogen.

3. The apparatus according to claim 2, characterized in that a thermal contact exists between the storage tank for liquefied hydrogen and the cold side of the regenerator.

4. The apparatus according to claim 1, characterized in that at least the cryogenic tank for the superconducting magnetic energy store, the storage tank for liquefied hydrogen, and the at least one regenerator are surrounded at least partially by a liquid nitrogen or oxygen bath which is connected to a cooling device, wherein a further thermal contact exists between the cooling device and the at least one regenerator.

5. A method for operating an apparatus for the storage of hydrogen and magnetic energy, as disclosed in claim 1, comprising the following steps
a) Adjusting the operating current for a superconducting magnetic energy store, which is configured with at least one magnetic coil, via current supply lines connected thereto, as a result of which electrical energy is supplied to or is extracted from the at least one magnetic coil in such a way that a magnetic field changes in the at least one magnetic coil, for which the field intensity does not drop below a minimum limit required for the ortho-para conversion and the para-ortho reconversion in the region of at least one regenerator, a relief valve, and a storage tank for liquid hydrogen;
b) Supplying compressed hydrogen at the ambient temperature via the warm end the at least one regenerator, wherein the hydrogen is cooled by releasing heat to the at least one storage medium located therein, and expansion of the hydrogen in the relieve valve, thereby causing the hydrogen to be mostly liquefied;
c) Catching and storing of the liquefied hydrogen in the form of a LH2 bath in the storage tank for liquefied hydrogen;
d) Supplying of hydrogen in the liquid form via the cold end of the at least one regenerator, wherein the hydrogen is warmed up through absorbing heat from the at least one storage medium and, as a result, changes to the gaseous phase, as well as discharging of the gaseous hydrogen via the warm end of the at least one regenerator;
wherein during the steps b) and d) the magnetic field of the at least one magnetic coil of the superconducting magnetic energy store supports the ortho-para conversion or the para-ortho reconversion of the hydrogen in such a way that by and large a thermal balance adjusts for each temperature.

6. The method according to claim 5, wherein the cold end of the at least one regenerator is thermally stabilized to match the temperature level of the LH2 bath in the storage tank for the liquefied hydrogen.

7. The method according to claim 5, wherein at least portions of the at least one regenerator are thermally stabilized to match the temperature level of a liquid nitrogen or liquid oxygen bath which at least in part surrounds least the storage tank for liquefied hydrogen and the at least one regenerator.

8. The method according to claim 5, wherein the hydrogen together with the oxygen is generated in a high-pressure electrolyser and the oxygen is initially cooled through heat transfer, is then subjected to a pressure expansion and is cooled further and/or is partially liquefied in the process, thereby contributing to the thermal stabilization of at least a portion of the at least one regenerator.
